(19) United States
(12) Patent Application Publication
(10) Pub. No.: US 2026/0010467 A1
(43) Pub. Date: Jan. 8, 2026

(54) MEMORY CAPACITY ADJUSTMENT METHOD AND APPARATUS, ELECTRONIC DEVICE, AND STORAGE MEDIUM

(71) Applicant: SUZHOU METABRAIN INTELLIGENT TECHNOLOGY CO., LTD., Suzhou, Jiangsu (CN)

(72) Inventors: Xiuqiang SUN, Suzhou, Jiangsu (CN); Shan CHENG, Suzhou, Jiangsu (CN); Baojun LIU, Suzhou, Jiangsu (CN); Binghui ZHANG, Suzhou, Jiangsu (CN)

(21) Appl. No.: 19/137,256

(22) PCT Filed: Aug. 12, 2024
(86) PCT No.: PCT/CN2024/111516

§ 371 Date: Jun. 9, 2025

(30) Foreign Application Priority Data
Nov. 30, 2023 (CN) 202311629028.7

(51) Int. Cl. G06F 12/02

(52) U.S. Cl. CPC G06F 12/023; G06F 2212/1036

(57) ABSTRACT

A method and apparatus for adjusting a memory capacity, an electronic device, and a storage medium are provided by embodiments of the present application. The method includes: reading serial presence detect (SPD) data of a target memory from a basic input output system (BIOS) image of a BIOS, wherein the SPD data is reserved and the target memory is a physical memory without an SPD controller; and adjusting a memory capacity of the target memory based on the SPD data of the target memory. In the embodiments of the present application, dynamic adjustment on the memory capacity without SPD controllers may be achieved and dynamic adjustment on the memory capacity of an overall server without manually disassembling the memory modules of the server may be met, actual business needs of customers are met, the service life of memories is prolonged, and operation and maintenance costs are reduced.

### CROSS-REFERENCE TO RELATED APPLICATION

This application claims the priority of the Chinese Patent application filed on Nov. 30, 2023 before the China National Intellectual Property Administration with the application number of 202311629028.7, and the title of “MEMORY CAPACITY ADJUSTMENT METHOD AND APPARATUS, ELECTRONIC DEVICE, AND STORAGE MEDIUM”, which is incorporated herein in its entirety by reference.

### FIELD

The present application relates to the technical field of memory adjustment and, more particularly, to a method and apparatus for adjusting a memory capacity, an electronic device, and a storage medium.

### BACKGROUND

In computer systems, data information usually needs to run on memories. Even if some processors may support a certain capacity of cache functions, these cache functions are only basic instruction execution requirements provided for the processors to start up and run. Similarly, the mirroring operation of basic input output systems (BIOSs) also depends on certain memory space. Self-check programs for server startup and applications running in systems are supported by a certain quantity of memories. Therefore, the memory is a physical device that has to exist in any architecture computer product. A memory in server operation involves settings of a plurality of parameters, such as integrated circuit and module manufacturers, operating frequency, operating voltage, speed, capacity, voltage, and row and column address bandwidths. These parameters are all controlled by serial presence detect (SPD) of the memory.

As a memory on a memory module, the SPD is used to store parameter information of the memory module. Such information is read and saved to a motherboard controller during computer startup, so that the system may configure a memory controller correctly, and most importantly, may automatically configure the operating frequency of the memory to ensure that the memory controller operates within an appropriate frequency range, thereby computer performance is improved. In different usage environments, conventional memories need to be transformed from a slot form to a motherboard patch form. Such transformation is only a separate change in memory link method and does not affect actual use. However, in some special occasions or in consideration of saving investment costs, the SPD controller needs to be removed from the memory, that is, no SPD controller is configured.

Generally, for the memory without the SPD controller, maintenance personnel need to disassemble the memory connected to the server to adjust the memory capacity. In this way, the service life of the memory may be shortened and operation and maintenance costs are increased′. Meanwhile, server manufacturers consume memories of different capacities from different batches of the same memory manufacturer, but memory modules contain SPD controllers and have different parameters. In the absence of SPD controllers, the mixed insertion of these memory modules into a server may result in technical problems such as failing to start up the server.

### SUMMARY

A method and apparatus for adjusting a memory capacity, an electronic device, and a storage medium are provided by the embodiments of the present application to solve the problems that manual disassembly in the related art shortens the service life of memories and increases operation and maintenance costs, and that the mixed insertion of memory modules into a server result in failing to start up the server.

In order to solve the above technical problem, the embodiments of the present application are implemented as follows:

In a first aspect, a method for adjusting a memory capacity is provided by an embodiment of the present application, which is applied to a basic input output system, wherein the method includes:
reading memory configuration data of a target memory from an image of the basic input output system, wherein the memory configuration data of the target memory is reserved, and the target memory is a physical memory without a memory configuration controller; and
adjusting a memory capacity of the target memory based on the memory configuration data of the target memory.

In some embodiments, before the reading the memory configuration data of the target memory from the image of the basic input output system, the method further includes:
obtaining memory configuration data of a plurality of types of memories including the target memory;
building a data structural body corresponding to each memory parameter in the image;
storing memory configuration data of each type of the memories in a corresponding data structural body based on memory parameters of each type of the memories; and
storing a data structural body of each type of the memories in a storage address corresponding to each type of the memories.

In some embodiments, the storing the memory configuration data of each type of the memories in the corresponding data structural body based on the memory parameters of each type of the memories includes:
obtaining memory capacity parameters of each type of the memories set by a user;
replacing original memory capacity parameters in the memory configuration data of each type of the memories based on the memory capacity parameters, to generate new memory configuration data of each type of the memories; and
storing the memory configuration data and the new memory configuration data in the corresponding data structural bodies, respectively, wherein different memory configuration data corresponds to different data structural bodies.

In some embodiments, before the storing the memory configuration data and the new memory configuration data in the corresponding data structural bodies, respectively, the method further includes:
creating a data structural body corresponding to the new memory configuration data in the storage address corresponding to each type of the memories to store the new memory configuration data.

In some embodiments, the reading the memory configuration data of the target memory from the image of the basic input output system includes:
obtaining, in response to server startup, a memory capacity parameter set by the user for the target memory after the basic input output system enters an initialization phase; and
reading, from the image, the memory configuration data, matching the memory capacity parameter, of the target memory.

In some embodiments, the reading, from the image of the basic input output system, the memory configuration data, matching the memory capacity parameter, of the target memory includes:
determining a target storage address corresponding to the target memory based on a memory type of the target memory; and
reading, based on a preset protocol, the memory configuration data that matches the memory capacity parameter from the target storage address.

In some embodiments, the obtaining the memory capacity parameter set by the user for the target memory includes:
in response to the basic input output system entering the initialization phase, displaying an interface of the basic input output system; and
obtaining the memory capacity parameter set by the user for the target memory based on the interface of the basic input output system.

In some embodiments, the reading, based on the preset protocol, the memory configuration data that matches the memory capacity parameter from the target storage address includes:
obtaining a target data structural body corresponding to the memory capacity parameter; and
reading, based on the preset protocol, the memory configuration data that matches the memory capacity parameter in the target data structural body from the target storage address.

In some embodiments, the obtaining the target data structural body corresponding to the memory capacity parameter includes:
obtaining a corresponding relationship that is pre-recorded between memory capacity parameters and data structural bodies; and
obtaining the target data structural body corresponding to the memory capacity parameter based on the memory capacity parameter and the corresponding relationship.

In some embodiments, the adjusting the memory capacity of the target memory based on the memory configuration data of the target memory includes:
assigning the memory configuration data of the target memory to the target memory; and
initializing the target memory to adjust the memory capacity of the target memory.

In some embodiments, after the adjusting the memory capacity of the target memory based on the memory configuration data of the target memory, the method further includes:
checking whether there are uninitialized memories among the memories accessing to a server of the basic input output system after the target memory has been initialized;
sequentially recognizing, in response to there being uninitialized memories among the memories, the uninitialized memories among the memories; and
sequentially reading memory configuration data of the uninitialized memories from the image to sequentially initialize the uninitialized memories.

In some embodiments, after the checking whether there are uninitialized memories among the memories of the server of the basic input output system, the method further includes:
determining whether the server is started up normally after checking that all the memories have been initialized; and
re-initializing the memories in response to the server being not started up normally.

In some embodiments, the re-initializing the memories includes:
obtaining a minimum memory parameter of the memories, wherein the minimum memory parameter is preset;
reading target memory configuration data corresponding to the minimum memory parameter from the image; and
assigning the target memory configuration data to the memories and initializing the memories.

In some embodiments, after the re-initializing the memories, the method further includes:
in response to the server being started up normally, sequentially reading memory configuration data of the memories from the image; and
sequentially initializing the memories based on the memory configuration data of the memories to adjust memory capacities of the memories.

In some embodiments, the in response to the server being started up normally, sequentially reading the memory configuration data of the memories from the image includes:
in response to the server being started up normally, obtaining memory capacity parameters of each type of the memories reset by a user; and
sequentially reading the memory configuration data corresponding to the memory capacity parameters from the image based on the memory capacity parameters.

In some embodiments, after the determining whether the server is started up normally, the method further includes:
ending the memory initialization process in response to the server being started up normally.

In some embodiments, the plurality of types of the memories at least include memories of different models and capacities from different memory manufacturers.

In a second aspect, an apparatus for adjusting a memory capacity is provided by an embodiment of the present application, which is applied to a basic input output system, wherein the apparatus includes:
a memory configuration data read module, configured to read memory configuration data of a target memory from an image of the basic input output system, wherein the memory configuration data of the target memory is reserved, and the target memory is a physical memory without a memory configuration controller; and
a memory capacity adjustment module, configured to adjust a memory capacity of the target memory based on the memory configuration data of the target memory.

In some embodiments, the apparatus further includes:
a memory configuration data obtaining module, configured to obtain memory configuration data of a plurality of types of memories including the target memory;
a data structural body building module, configured to build a data structural body corresponding to each memory parameter in the image;
a memory configuration data storage module, configured to store memory configuration data of each type of the memories in a corresponding data structural body based on memory parameters of each type of the memories; and
a data structural body storage module, configured to store a data structural body of each type of the memories in a storage address corresponding to each type of the memories.

In some embodiments, the memory configuration data storage module includes:
a memory capacity parameter obtaining unit, configured to obtain memory capacity parameters of each type of the memories set by a user;
a new memory configuration data generation unit, configured to replace original memory capacity parameters in the memory configuration data of each type of the memories based on the memory capacity parameters, to generate new memory configuration data of each type of the memories; and
a memory configuration data storage unit, configured to store the memory configuration data and the new memory configuration data in the corresponding data structural bodies, respectively, wherein different memory configuration data corresponds to different data structural bodies.

In some embodiments, the memory configuration data read module includes:
a memory parameter setting unit, configured to obtain, in response to server startup, the memory capacity parameter set by the user for the target memory after the basic input output system enters an initialization phase; and
a memory configuration data read unit, configured to read, from the image, the memory configuration data, matching the memory capacity parameter, of the target memory.

In some embodiments, the memory configuration data read unit includes:
a target address determination subunit, configured to determine a target storage address corresponding to the target memory based on a memory type of the target memory; and
a memory configuration data read subunit, configured to read, based on a preset protocol, the memory configuration data that matches the memory capacity parameter from the target storage address.

In some embodiments, the memory configuration data read subunit includes:
a target structural body obtaining subunit, configured to obtain a target data structural body corresponding to the memory capacity parameter; and
a memory configuration data obtaining subunit, configured to read, based on the preset protocol, the memory configuration data that matches the memory capacity parameter in the target data structural body from the target storage address.

In some embodiments, the memory capacity adjustment module includes:
a memory configuration data assignment unit, configured to assign the memory configuration data of the target memory to the target memory; and
a memory capacity adjustment unit, configured to initialize the target memory to adjust the memory capacity of the target memory.

In some embodiments, the apparatus further includes:
an uninitialized memory check module, configured to check whether there are uninitialized memories among the memories accessing to a server of the basic input output system after the target memory has been initialized;
an uninitialized memory recognition module, configured to sequentially recognize, in response to there being uninitialized memories among the memories, the uninitialized memories among the memories; and
a memory initialization module, configured to sequentially read the memory configuration data of the uninitialized memories from the image to sequentially initialize the uninitialized memories.

In some embodiments, the apparatus further includes:
a normal startup determination module, configured to determine whether the server is started up normally after checking that all the memories have been initialized; and
a memory re-initialization module, configured to re-initialize the memories in response to the server being not started up normally.

In some embodiments, the memory re-initialization module includes:
a minimum memory parameter obtaining unit, configured to obtain a minimum memory parameter of the memories, wherein the minimum memory parameter is preset;
a target memory configuration data read unit, configured to read target memory configuration data corresponding to the minimum memory parameter from the image; and
a memory initialization unit, configured to assign the target memory configuration data
to the memories and initialize the memories.

In some embodiments, the apparatus further includes:
a memory configuration data read module, configured to in response to the server being started up normally, sequentially read the memory configuration data of the memories from the image; and
a memory adjustment module, configured to sequentially initialize the memories based on the memory configuration data of the memories to adjust the memory capacities of the memories.

In some embodiments, the apparatus further includes:
an initialization process ending module, configured to end the memory initialization process in response to the server being started up normally.

In a third aspect, an electronic device is provided by an embodiment of the present application, which includes:
a memory, a processor, and a computer program stored on the memory and being capable of executing on the processor, wherein the computer program, in response to being executed by the processor, implements the method for adjusting the memory capacity as described in any one of the above embodiments.

In a fourth aspect, a computer non-transitory readable storage medium is provided by an embodiment of the present application, wherein instructions in the computer non-transitory readable storage medium, in response to being executed by a processor of an electronic device, enable the electronic device to perform the method for adjusting the memory capacity as described in any one of the above embodiments.

In the embodiments of the present application, SPD data of the target memory is read from the BIOS image of the BIOS, wherein the SPD data of the target memory is reserved and the target memory is a physical memory without an SPD controller. The memory capacity of the target memory is adjusted based on the SPD data of the target memory. In the embodiments of the present application, by storing SPD data of a memory in the BIOS image, the SPD data reserved in the BIOS image may be directly assigned to the memory when the server is started up, thereby memory capacity adjustment without an SPD controller may be achieved; and manual disassembly is not required to adjust the memory capacity, thereby the problem that the service life of the memory is shortened due to frequent disassembly is avoided, and operation and maintenance costs are reduced. Meanwhile, the problem that the server cannot be started up may also be avoided when the memories of different batches and capacities from the same memory manufacturer access to the server.

The above description is merely a summary of the technical solutions of the present application. In order to understand the technical means of the present application more clearly, it may be implemented in accordance with the content of the description; and in order to make the above and other objectives, features and advantages of the present application more obvious and easier to understand, implementations of the present application are elaborated below.

### BRIEF DESCRIPTION OF THE DRAWINGS

In order to explain the technical solutions of the embodiments of the present application more clearly, a brief description will be given below with reference to the drawings which are used in the description of the embodiments of the present application. It is obvious that the drawings in the description below are merely some embodiments of the present application. A person skilled in the art may obtain other drawings according to these drawings without involving any inventive effort.

FIG. 1 is a step flowchart of a method for adjusting a memory capacity according to an embodiment of the present application;

FIG. 2 is a step flowchart of a method for storing SPD data according to an embodiment of the present application;

FIG. 3 is a step flowchart of another method for storing SPD data according to an embodiment of the present application;

FIG. 4 is a step flowchart of a method for reading SPD data according to an embodiment of the present application;

FIG. 5 is a step flowchart of another method for reading SPD data according to an embodiment of the present application;

FIG. 6 is a step flowchart of still another method for reading SPD data according to an embodiment of the present application;

FIG. 7 is a step flowchart of another method for adjusting a memory capacity according to an embodiment of the present application;

FIG. 8 is a step flowchart of a method for initializing memories according to an embodiment of the present application;

FIG. 9 is a step flowchart of another method for initializing memories according to an embodiment of the present application;

FIG. 10 is a step flowchart of still another method for initializing memories according to an embodiment of the present application;

FIG. 11 is a step flowchart of still another method for adjusting a memory capacity according to an embodiment of the present application;

FIG. 12 is a schematic diagram of a server memory physical link according to an embodiment of the present application;

FIG. 13 is a schematic diagram of a server startup process according to an embodiment of the present application;

FIG. 14 is a schematic diagram of a hardware structure according to an embodiment of the present application;

FIG. 15 is a schematic structural diagram of an apparatus for adjusting a memory capacity according to an embodiment of the present application; and

FIG. 16 is a schematic structural diagram of an electronic device according to an embodiment of the present application.

### DETAILED DESCRIPTION

The technical solutions in the embodiments of the present application will be clearly and completely described in detail with reference to the accompanying drawings therein. Apparently, the described embodiments are some but not all of the embodiments of the present application. All other embodiments obtained by those of ordinary skill in the art based on the embodiments of the present application without creative efforts shall fall within the scope of protection of the present application.

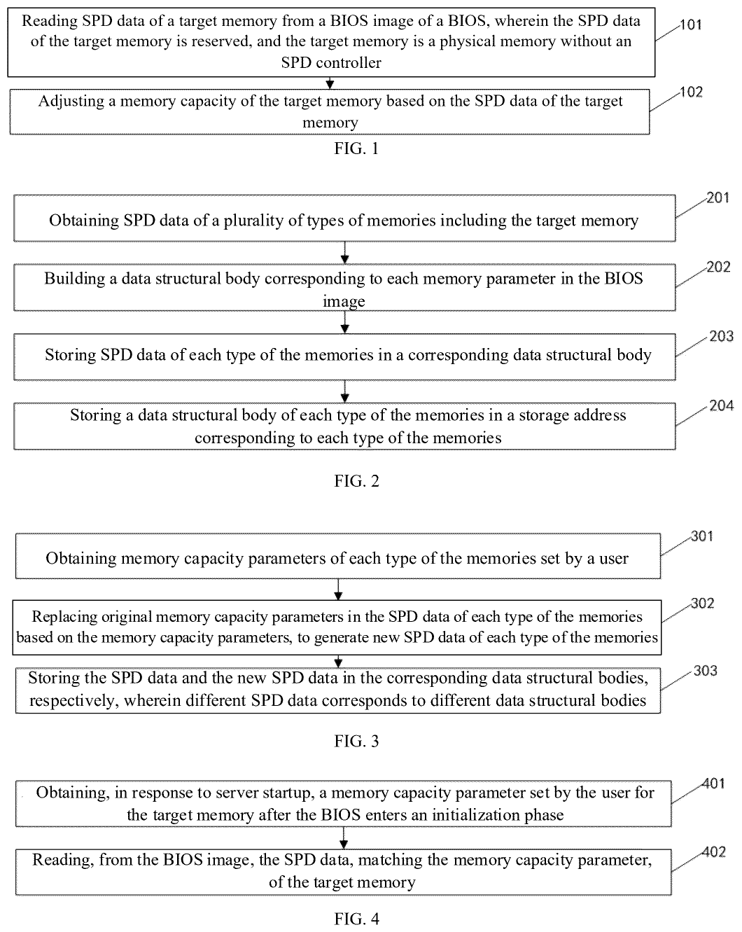

Referring to FIG. 1, which illustrates a step flowchart of a method for adjusting a memory capacity according to an embodiment of the present application. The method for adjusting the memory capacity may be applied to a basic input output system (BIOS). As shown in FIG. 1, the method for adjusting the memory capacity may include step 101 and step 102.

Step 101: reading reserved SPD data of a target memory from a BIOS image of a BIOS, wherein the SPD data of the target memory is reserved and the target memory is a physical memory without an SPD controller.

The embodiments of the present application may be applied to a scenario of dynamically adjusting the memory capacity of a memory without an SPD controller.

The embodiments of the present application may be applied to the BIOS, also known as a basic input output system, that is, an executing subject is the BIOS.

In an implementation, SPD data of a memory, also known as memory configuration data, may be pre-stored in the BIOS image of the BIOS, thus an SPD controller, also known as a memory configuration controller, does not need to be disposed in the memory. The storage process for the SPD data may be described in detail below with reference to FIG. 2.

Referring to FIG. 2, which illustrates a step flowchart of a method for storing SPD data according to an embodiment of the present application. As shown in FIG. 2, the method for storing the SPD data may include step 201, step 202, step 203, and step 204.

Step 201: obtaining SPD data of a plurality of types of memories including the target memory.

In the present embodiment, when data storage of SPD is performed, the SPD data of the plurality of types of memories may be obtained, wherein the plurality of types of the memories may include the target memory.

In practical applications, the plurality of types of the memories may include memories of different models and different capacities from different memory manufacturers.

When the SPD data is stored, the SPD data of the plurality of types of memories may be obtained. The SPD data of the plurality of types of the memories may be defined by the memory manufacturers during producing the memories.

After the SPD data of the plurality of types of the memories is obtained, step 202 is performed.

Step 202: building a data structural body corresponding to each memory parameter in the BIOS image.

In this example, the data structural body refers to a type of data structure used to store data. In C language, the data structural body refers to one of aggregated data types. The data structural body may be declared as a variable, a pointer, an array, or the like to implement complex data structure. The data structural body is also a collection of some elements, and these elements are called members of the structural body. In this example, the SPD data may be stored as a member of the data structural body.

After the SPD data of the plurality of types of the memories is obtained, the data structural body corresponding to each memory parameter may be built in the BIOS image. In this example, the SPD data of one type of memory parameters corresponds to one data structural body.

After the data structural body corresponding to each memory parameter is built in the BIOS image, step 203 is performed.

Step 203: storing SPD data of each type of the memories in a corresponding data structural body based on the memory parameters of each type of the memories.

After the data structural body corresponding to each memory parameter is built in the BIOS image, the SPD data of each type of the memories may be stored in the corresponding data structural body based on the memory parameters of each type of the memories.

Step 204: storing a data structural body of each type of the memories in a storage address corresponding to each type of the memories.

The data structural body of each type of the memories may be stored in the storage address corresponding to each type of the memories. In an implementation, the storage address may be an Inter-Integrated Circuit (I2C) address, each type of the memories may correspond to one I2C address, and a plurality of data structural bodies may be stored in one I2C address. As shown in FIG. 12, the SPD address corresponding to memory 0 may include: SPD address A0, SPD address A2, SPD address A4, SPD address A6, SPD address BO, SPD address B2, SPD address B4, and SPD address B6 under CPU0; and SPD address C0, SPD address C2, SPD address C4, SPD address C6, SPD address D0, SPD address D2, SPD address D4, and SPD address D6 under CPU1, and the like. A central processing unit (CPU) may read the corresponding SPD data from the SPD address through an I2C protocol.

In the embodiment of the present application, by storing different types of SPD data in the BIOS image, the memory capacity of a memory may be dynamically adjusted after the SPD controller is removed from memory.

In the present embodiment, in addition to the SPD data of memories defined by the memory manufacturers, a user may also set corresponding memory capacity parameters for different memories, to replace original memory capacity parameters of the obtained SPD data, and to generate new SPD data for storage. This implementation process may be described in detail below with reference to FIG. 3.

Referring to FIG. 3, which illustrates a step flowchart of another method for storing SPD data according to an embodiment of the present application. As shown in FIG. 3, the method for storing SPD data may include step 301, step 302, and step 303.

Step 301: obtaining memory capacity parameters of each type of the memories set by a user.

In the embodiment of the present application, after the SPD data of the plurality of types of the memories is obtained, the user may set the memory capacity parameters of each type of the memories.

In an implementation, the user may set one type or more types of memory capacity parameters for each type of the memories, depending on business requirements. This embodiment does not limit this.

After the memory capacity parameters of each type of the memories set by the user are obtained, step 302 is performed.

Step 302: replacing original memory capacity parameters in the SPD data of each type of the memories based on the memory capacity parameters, to generate new SPD data of each type of the memories.

After the memory capacity parameters of each type of the memories set by the user are obtained, the original memory capacity parameters in the SPD data of each type of the memories may be replaced based on the memory capacity parameters, to generate the new SPD data of each type of the memories.

Step 303: storing the SPD data and the new SPD data in the corresponding data structural bodies, respectively, wherein different SPD data corresponds to different data structural bodies.

Furthermore, a data structural body corresponding to the new SPD data may be created in the storage address corresponding to each type of the memories, then the SPD data and the new SPD data are stored in the corresponding data structural bodies, respectively, and different SPD data corresponds to different data structural bodies.

In the present embodiment, the user may customize the memory capacity parameters of memories to adjust memory capacities subsequently as needed, set physical memories according to user's actual needs, and dynamically adjust the memory capacity of the server to meet customer's actual business needs.

After the SPD data is stored, when the target memory is initialized, the reserved SPD data of the target memory may be read from the BIOS image of the BIOS, wherein the target memory is a physical memory without an SPD controller. In an implementation, after the BIOS enters an initialization phase, the user may set the memory capacity parameter of the target memory, and then the SPD data that matches the memory capacity parameter may be read from the BIOS image. This implementation process may be described in detail below in conjunction with FIG. 4.

Referring to FIG. 4, which illustrates a step flowchart of a method for reading SPD data according to an embodiment of the present application. As shown in FIG. 4, the method for reading the SPD data may include step 401 and step 402.

Step 401: obtaining, in response to server startup, a memory capacity parameter set by the user for the target memory after the BIOS enters an initialization phase.

In the embodiment of the present application, after the server is started up, the BIOS may enter the initialization phase. As shown in FIG. 14, after the server is started up, the BIOS begins to initialize a memory. At this moment, a BIOS interface may be displayed, and the user may set the memory capacity parameter for the target memory in the BIOS interface, that is, the user sets a memory capacity that needs to be adjusted for the target memory.

After the memory capacity parameter set by the user for the target memory is obtained, step 402 is performed.

Step 402: reading, from the BIOS image, the SPD data, matching the memory capacity parameter, of the target memory.

After the memory capacity parameter set by the user for the target memory is obtained, the SPD data, matching the memory capacity parameter, of the target memory may be read from the BIOS image, and then the SPD data contains the memory capacity parameter set by the user. As shown in FIG. 14, the BIOS may read memory SPD data through an I2C protocol. Firstly, the BIOS may obtain a preset value of a memory capacity option, and read preset SPD data according to the preset value.

In the embodiment of the present application, the user customizes the memory capacity parameter of the target memory, the memory capacity of the target memory may be set according to user's actual needs, meeting user's actual business needs.

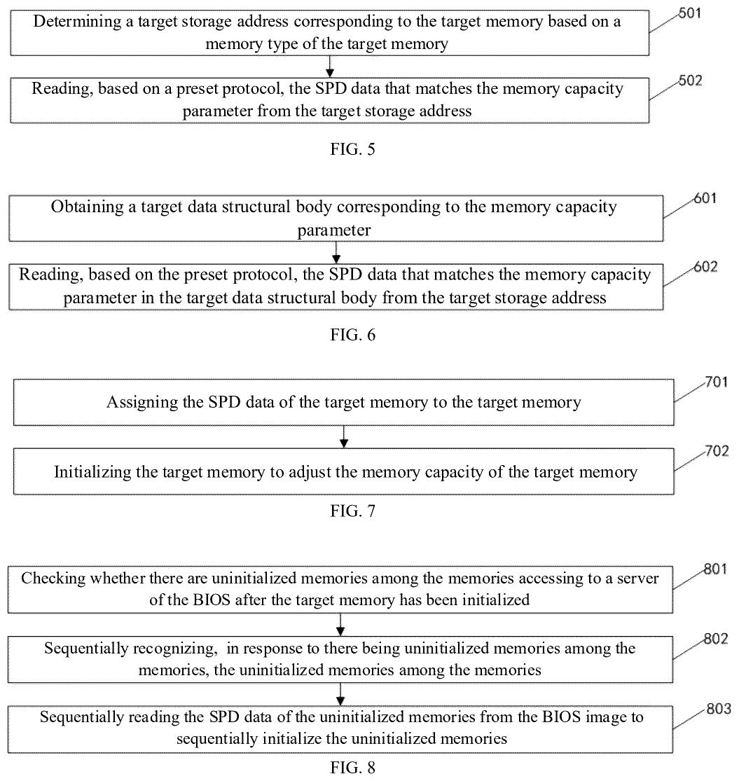

In an implementation, when the SPD data that matches the memory capacity parameter is read, the storage address corresponding to the target memory may be obtained, and then the corresponding SPD data may be read from the storage address. This implementation process may be described in detail below in conjunction with FIG. 5.

Referring to FIG. 5, which illustrates a step flowchart of another method for reading SPD data according to an embodiment of the present application. As shown in FIG. 5, the method for reading the SPD data may include step 501 and step 502.

Step 501: determining a target storage address corresponding to the target memory based on the memory type of the target memory.

In the present embodiment, after the memory capacity parameter of the target memory set by the user is obtained, the target storage address corresponding to the target memory may be determined based on the memory type of the target memory, that is, at least one type of the SPD data of the target memory is stored in the target storage address.

After the target storage address corresponding to the target memory is determined based on the memory type of the target memory, step 502 is performed.

Step 502: reading, based on a preset protocol, the SPD data that matches the memory capacity parameter from the target storage address.

After the target storage address corresponding to the target memory is determined based on the memory type of the target memory, the SPD data that matches the memory capacity parameter may be read from the target storage address based on the preset protocol. In this example, the target storage address may be an I2C address, and the preset protocol may be an I2C protocol. After the target storage address is determined, the SPD data that matches the memory capacity parameter may be read from the I2C address based on the I2C protocol.

In an implementation, after the target storage address corresponding to the target memory is determined, a corresponding target data structural body may be further determined based on the memory capacity parameter, so that the corresponding SPD data may be read from the target data structural body of the target memory. This implementation process may be described in detail below with reference to FIG. 6.

Referring to FIG. 6, which illustrates a step flowchart of still another method for reading SPD data according to an embodiment of the present application. As shown in FIG. 6, the method for reading the SPD data may include step 601 and step 602.

Step 601: obtaining a target data structural body corresponding to the memory capacity parameter.

In the embodiment of the present application, after the memory capacity parameter of the target memory set by the user is obtained, the target data structural body corresponding to the memory capacity parameter may be obtained. It may be understood that each type of SPD data corresponds to a data structural body, and the BIOS may pre-record the corresponding relationship. Then, after the memory capacity parameter of the target memory set by the user is obtained, the target data structural body corresponding to the memory capacity parameter may be determined based on the corresponding relationship.

After the target data structural body corresponding to the memory capacity parameter is obtained, step 602 is performed.

Step 602: reading, based on the preset protocol, the SPD data that matches the memory capacity parameter in the target data structural body from the target storage address.

After the target data structural body corresponding to the memory capacity parameter is obtained, the SPD data that matches the memory capacity parameter in the target data structural body may be read from the target storage address based on the preset protocol.

In the embodiment of the present application, a corresponding storage address is preset for each memory, and corresponding data structural bodies are designed for different SPD data of the memory, so that after a memory capacity parameter set by the user is obtained, the corresponding SPD data may be quickly read, the data read efficiency is improved, thus memory initialization efficiency may be improved.

After the reserved SPD data of the target memory is read from the BIOS image of the BIOS, step 102 is performed.

Step 102: adjusting a memory capacity of the target memory based on the SPD data of the target memory.

After the reserved SPD data of the target memory is read from the BIOS image of the BIOS, the memory capacity of the target memory may be adjusted based on the SPD data of the target memory. The process of adjusting the memory capacity may be described in detail below with reference to FIG. 7.

Referring to FIG. 7, which illustrates a step flowchart of another method for adjusting a memory capacity according to an embodiment of the present application. As shown in FIG. 7, the method for adjusting the memory capacity may include step 701 and step 702.

Step 701: assigning the SPD data of the target memory to the target memory.

In the present embodiment, after the SPD data of the target memory is read from the BIOS image, the SPD data of the target memory may be assigned to the target memory. As shown in FIG. 14, the BIOS may assign the SPD data set in the BIOS to the memory and initialize the memory.

Step 702: initializing the target memory to adjust the memory capacity of the target memory.

The target memory may be initialized to adjust the memory capacity of the target memory.

In the embodiment of the present application, by storing the SPD data of the memories in the BIOS image, the SPD data reserved in the BIOS image may be directly assigned to the memory when the server is started up, thereby memory capacity adjustment without an SPD controller is achieved; and manual disassembly is not required to adjust the memory capacity, thereby the problem that the service life of the memory is shortened due to frequent disassembly is avoided, and operation and maintenance costs are reduced. Meanwhile, the problem that the server cannot be started up may also be avoided when the memories of different batches and capacities from the same memory manufacturer access to the server.

In an implementation, after the target memory has been initialized, whether there are uninitialized memories among the memories accessing to a server of the BIOS may be further checked. When there are uninitialized memories among the memories accessing to the server of the BIOS, the uninitialized memories may be sequentially initialized. This implementation process may be described in detail below with reference to FIG. 8.

Referring to FIG. 8, which illustrates a step flowchart of a method for initializing memories according to an embodiment of the present application. As shown in FIG. 8, the method for initializing memories may include step 801, step 802, and step 803.

Step 801: checking whether there are uninitialized memories among the memories accessing to a server of the BIOS after the target memory has been initialized.

In the embodiment of the present application, after the target memory has been initialized, whether there are uninitialized memories among the memories accessing to the server of the BIOS may be checked. As shown in FIG. 14, after the initialization of the current memory is completed, it may be determined whether the initialization of all memories is completed. When the initialization of all memories is not completed, the next memory is initialized according to the above processes of reading and assigning SPD data until the initialization of all memories is completed.

Step 802: sequentially recognizing, in response to there being uninitialized memories among the memories, the uninitialized memories among the memories.

When there are uninitialized memories among the memories accessing to the server of the BIOS, the uninitialized memories among the memories accessing to the server of the BIOS may be sequentially recognized.

Step 803: sequentially reading the SPD data of the uninitialized memories from the BIOS image to sequentially initialize the uninitialized memories.

The SPD data of the uninitialized memories may be sequentially read from the BIOS image to sequentially initialize the uninitialized memories. For example, the uninitialized memories include a memory 1, a memory 2, and a memory 3. The SPD data of the memory 1 may be first read from the BIOS image and assigned to the memory 1, and the memory 1 is initialized. Then, the SPD data of the memory 2 may be read from the BIOS image and assigned to the memory 2, and the memory 2 is initialized. Finally, the SPD data of the memory 3 is read from the BIOS image and assigned to the memory 3, and the memory 3 is initialized.

It may be understood that the above example is listed only for a better understanding of the technical solution in the embodiment of the present application, but does not serve as the only limitation on the present embodiment.

In the embodiment of the present application, by checking whether all memories have been initialized and sequentially initializing uninitialized memories, the initialization of all memories may be completed to avoid the situation where normal startup cannot be implemented in the presence of uninitialized memories

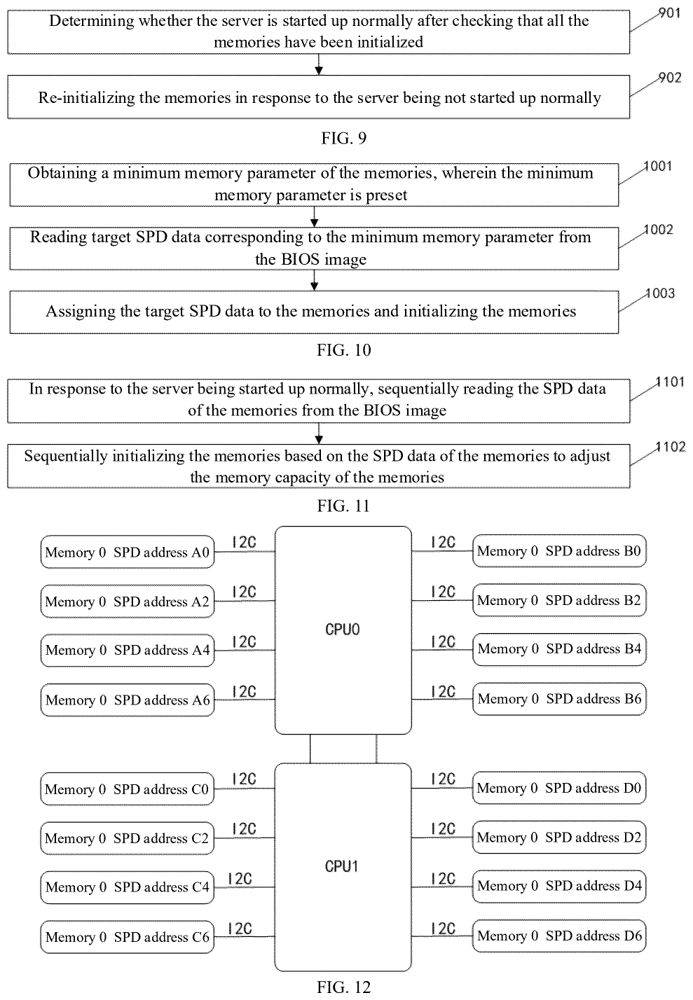

In an implementation, when it is checked that all the memories in the server have been initialized, it may be determined whether the server is started up normally. When the server is started up normally, the memory initialization process ends. When the server is not started up normally, the memories may be re-initialized. This implementation process will be described in detail below with reference to FIG. 9.

Referring to FIG. 9, which illustrates a step flowchart of another method for initializing memories according to an embodiment of the present application. As shown in FIG. 9, the method for initializing the memories may include step 901 and step 902.

Step 901: determining whether the server is started up normally after checking that all the memories have been initialized.

In the present embodiment, after checking that all the memories accessing to the server have been initialized, the server continues to start, and the BIOS determines whether the server may be started up normally.

When the server is not started up normally, step 902 is performed.

Step 902: re-initializing the memories in response to the server being not started up normally.

When it is determined that the server is not started up normally, in response to the server being not started up normally, the memories may be re-initialized. That is, all the memories accessing to the server will be re-initialized.

In this example, a minimum memory parameter of all the memories may be obtained, and all the memories may be re-initialized based on the SPD data corresponding to the minimum memory parameters. This implementation process may be described in detail below with reference to FIG. 10.

Referring to FIG. 10, which illustrates a step flowchart of still another method for initializing memories according to an embodiment of the present application. As shown in FIG. 10, the method for initializing the memories may include step 1001, step 1002, and step 1003.

Step 1001: obtaining a minimum memory parameter of the memories, wherein the minimum memory parameter is preset.

In the present embodiment, when it is determined that the server is not started up normally, the preset minimum memory parameter of the memories accessing to the server may be obtained.

It may be understood that the minimum memory parameter may be set by memory manufacturers when producing the memories.

After the preset minimum memory parameter of the memories is obtained, step 1002 is performed.

Step 1002: reading target SPD data corresponding to the minimum memory parameter from the BIOS image.

After the preset minimum memory parameter of the memories are obtained, the target SPD data corresponding to the minimum memory parameter may be read from the BIOS image.

Step 1003: assigning the target SPD data to the memories and initializing the memories.

The target SPD data may be assigned to the memories, and the memories may be initialized before the server continues to start. As shown in FIG. 14, when the server is started up normally, the initialization of the memories is completed. When the server is not started up normally, the memories are re-initialized and minimum-capacity SPD data is loaded.

In the embodiment of the present application, when the server fails to start normally, the memories are re-initialized based on the SPD data corresponding to the minimum memory parameter, the problem that the server fails to start normally after the memory capacity is adjusted is solved.

In an implementation, after the memories are re-initialized and the server is started up normally, the memory capacity of the memories is not adjusted, that is, the memory capacity adjustment process ends.

In another implementation, after the memories are re-initialized and the server is started up normally, the user may set memory parameters to adjust the memory capacities of the memories. This implementation process may be described in detail below with reference to FIG. 11.

Referring to FIG. 11, which illustrates a step flowchart of still another method for adjusting a memory capacity according to an embodiment of the present application. As shown in FIG. 11, the method for adjusting the memory capacity may include step 1101 and step 1102.

Step 1101: in response to the server being started up normally, sequentially reading the SPD data of the memories from the BIOS image.

In the present embodiment, after the memories are re-initialized and the server is started up normally, the SPD data of the memories may be sequentially read from the BIOS image in response to the server being started up normally. The user may reset the memory capacity parameters of the memories, and then the SPD data corresponding to the memory capacity parameters may be read from the BIOS image.

Step 1102: sequentially initializing the memories based on the SPD data of the memories to adjust the memory capacity of the memories.

The memories may be sequentially initialized based on the SPD data of the memories to adjust the memory capacity of the memories.

In the embodiment of the present application, the capacity of the memories is adjusted based on the SPD data after the server is started up, dynamic adjustment on the memory capacity may be achieved.

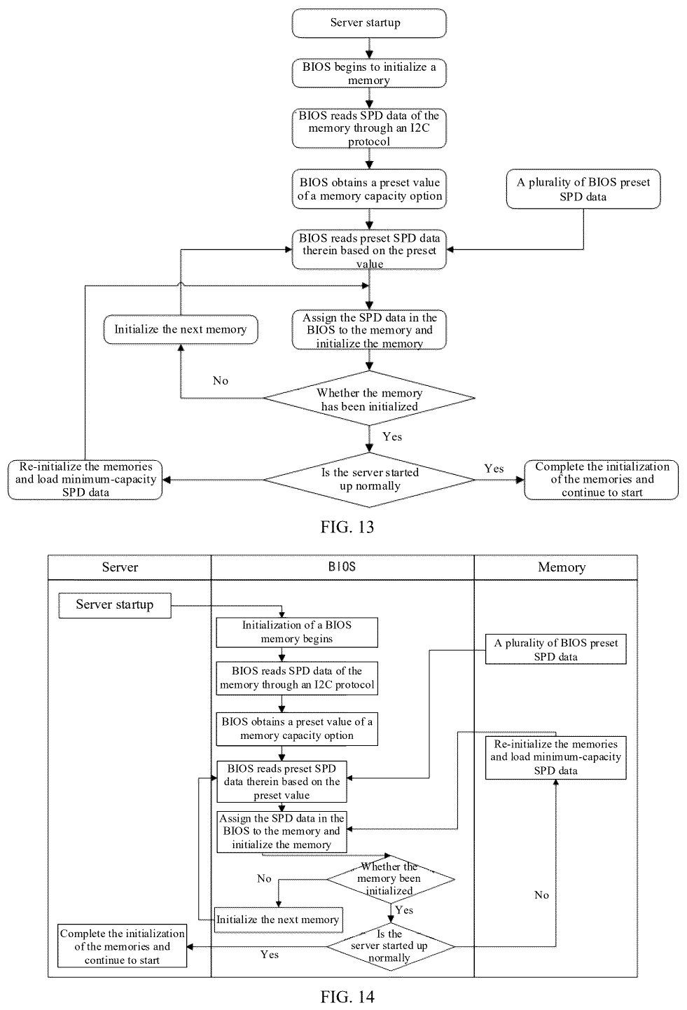

The above implementation process may be completely described below with reference to FIG. 13.

As shown in FIG. 13, after the server is started up, the BIOS begins to initialize a memory. Firstly, the BIOS reads SPD data from the I2C address of the memory through an I2C protocol. When reading the SPD data, the BIOS first obtains a setting parameter of a memory capacity option for the memory capacity in a BIOS interface, that is, a preset value of a memory capacity option. After obtaining memory parameter setting of the BIOS option, the BIOS reads the SPD data corresponding to the parameter. After obtaining a preset SPD data parameter in the BIOS based on the setting of the BIOS option, the BIOS assigns the parameter to the currently recognized memory and initializes the memory. After the memory module recognized by the BIOS has been initialized, the parameter of the next memory is read and the next memory is initialized. After all the memories have been initialized, the server continues to start. When the server cannot continue to start after initialization, the memories are re-initialized, the memory parameters are set to minimum values, and the set value of the memory capacity option of the BIOS is ignored.

In the method for adjusting the memory capacity according to the embodiment of the present application, the reserved SPD data of the target memory is read from the BIOS image of the BIOS, wherein the target memory is a physical memory without an SPD controller. The memory capacity of the target memory is adjusted based on the SPD data of the target memory. In the embodiment of the present application, by storing the SPD data of the memories in the BIOS image, the SPD data reserved in the BIOS image may be directly assigned to the memory when the server is started up, thereby memory capacity adjustment without an SPD controller is achieved; and manual disassembly is not required to adjust the memory capacity, thereby the problem that the service life of the memory is shortened due to frequent disassembly is avoided, and operation and maintenance costs are reduced. Meanwhile, the problem that the server cannot be started up may also be avoided when the memories of different batches and capacities from the same memory manufacturer access to the server.

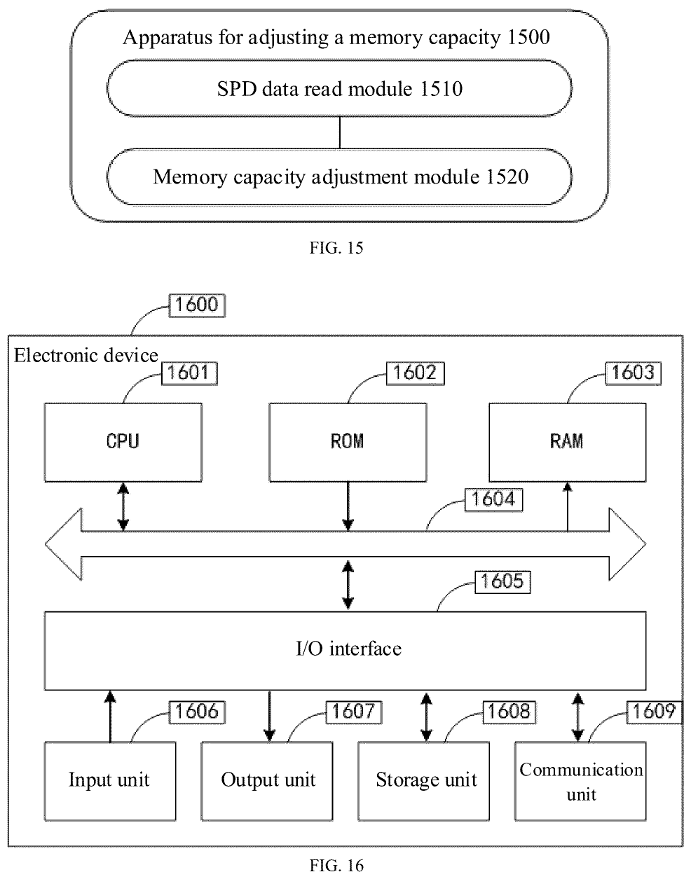

Referring to FIG. 15, which illustrates a schematic structural diagram of an apparatus for adjusting a memory capacity according to an embodiment of the present application. The apparatus for adjusting the memory capacity may be applied to a BIOS. As shown in FIG. 15, the apparatus for adjusting the memory capacity 1500 may include the following modules:
an SPD data read module 1510, configured to read SPD data of a target memory from a BIOS image of the BIOS, wherein the SPD data of the target memory is reserved and the target memory is a physical memory without an SPD controller; and
a memory capacity adjustment module 1520, configured to adjust a memory capacity of the target memory based on the SPD data of the target memory.

In some embodiments, the apparatus further includes:
an SPD data obtaining module, configured to obtain SPD data of a plurality of types of memories including the target memory;
a data structural body building module, configured to build a data structural body corresponding to each memory parameter in the BIOS image;
an SPD data storage module, configured to store SPD data of each type of the memories in a corresponding data structural body based on memory parameters of each type of the memories; and
a data structural body storage module, configured to store a data structural body of each type of the memories in a storage address corresponding to each type of the memories.

In some embodiments, the SPD data storage module includes:
a memory capacity parameter obtaining unit, configured to obtain memory capacity parameters of each type of the memories set by a user;
a new SPD data generation unit, configured to replace original memory capacity parameters in the SPD data of each type of the memories based on the memory capacity parameters, to generate new SPD data of each type of the memories; and
an SPD data storage unit, configured to store the SPD data and the new SPD data in the corresponding data structural bodies, respectively, wherein different SPD data corresponds to different data structural bodies.

In some embodiments, the SPD data read module includes:
a memory parameter setting unit, configured to obtain, in response to server startup, the memory capacity parameter set by the user for the target memory after the BIOS enters an initialization phase; and
an SPD data read unit, configured to read, from the BIOS image, the SPD data, matching the memory capacity parameter, of the target memory.

In some embodiments, the SPD data read unit includes:
a target address determination subunit, configured to determine a target storage address corresponding to the target memory based on a memory type of the target memory; and
an SPD data read subunit, configured to read, based on a preset protocol, the SPD data
that matches the memory capacity parameter from the target storage address.

In some embodiments, the SPD data read subunit includes:
a target structural body obtaining subunit, configured to obtain a target data structural body corresponding to the memory capacity parameter; and
an SPD data obtaining subunit, configured to read, based on the preset protocol, the SPD data that matches the memory capacity parameter in the target data structural body from the target storage address.

In some embodiments, the memory capacity adjustment module includes:
an SPD data assignment unit, configured to assign the SPD data of the target memory to the target memory; and
a memory capacity adjustment unit, configured to initialize the target memory to adjust the memory capacity of the target memory.

In some embodiments, the apparatus further includes:
an uninitialized memory check module, configured to check whether there are uninitialized memories among the memories accessing to a server of the BIOS after the target memory has been initialized;
an uninitialized memory recognition module, configured to sequentially recognize, in response to there being uninitialized memories among the memories, the uninitialized memories among the memories; and
a memory initialization module, configured to sequentially read the SPD data of the uninitialized memories from the BIOS image to sequentially initialize the uninitialized memories.

In some embodiments, the apparatus further includes:
a normal startup determination module, configured to determine whether the server is started up normally after checking that all the memories have been initialized; and
a memory re-initialization module, configured to re-initialize the memories in response to the server being not started up normally.

In some embodiments, the memory re-initialization module includes:
a minimum memory parameter obtaining unit, configured to obtain a minimum memory parameter of the memories, wherein the minimum memory parameter is preset;
a target SPD data read unit, configured to read target SPD data corresponding to the minimum memory parameter from the BIOS image; and
a memory initialization unit, configured to assign the target SPD data to the memories and initialize the memories.

In some embodiments, the apparatus further includes:
a memory SPD data read module, configured to sequentially read the SPD data of the memories from the BIOS image in response to the server being started up normally; and
a memory adjustment module, configured to sequentially initialize the memories based on the SPD data of the memories to adjust the memory capacity of the memories.

In some embodiments, the apparatus further includes:
an initialization process ending module, configured to end the memory initialization process in response to the server being started up normally.

In the apparatus for adjusting a memory capacity according to the embodiment of the present application, the SPD data of the target memory is read from the BIOS image of the BIOS, wherein the SPD data of the target memory is reserved and the target memory is a physical memory without an SPD controller. The memory capacity of the target memory is adjusted based on the SPD data of the target memory. In the embodiments of the present application, by storing SPD data of a memory in the BIOS image, the SPD data reserved in the BIOS image may be directly assigned to the memory when the server is started up, thereby memory capacity adjustment without an SPD controller may be achieved; and manual disassembly is not required to adjust the memory capacity, thereby the problem that the service life of the memory is shortened due to frequent disassembly is avoided, and operation and maintenance costs are reduced. Meanwhile, the problem that the server cannot be started up may also be avoided when the memories of different batches and capacities from the same memory manufacturer access to the server.

In addition, an electronic device is further provided by an embodiment of the present application, which includes: a memory, a processor, and a computer program stored on the memory and being capable of executing on the processor, wherein the computer program, when executed by the processor, implements the above method for adjusting the memory capacity.

FIG. 16 illustrates a schematic structural diagram of an electronic device 1600 according to an embodiment of the present application. As shown in FIG. 16, the electronic device 1600 includes a central processing unit (CPU) 1601, which may perform various appropriate operations and processes based on computer program instructions stored in a read-only memory (ROM) 1602 or computer program instructions loaded from a storage unit 1608 to a random access memory (RAM) 1603. In the RAM 1603, various programs and data required for the operation of the electronic device 1600 may also be stored. The CPU 1601, the ROM 1602, and the RAM 1603 are connected to each other through a bus 1604. An input/output (I/O) interface 1605 is also connected to the bus 1604.

A plurality of components in the electronic device 1600 are connected to the I/O interface 1605, including: an input unit 1606, such as a keyboard, a mouse, or a microphone; an output unit 1607, such as various types of displays and speakers; a storage unit 1608, such as a magnetic disk or an optical disk; and a communication unit 1609, such as a network card, a modem, or a wireless communication transceiver. The communication unit 1609 allows the electronic device 1600 to exchange information/data with other devices over a computer network such as the Internet and/or various telecommunication networks.

Various processes and treatments described above may be executed by the processing unit 1601. For example, the method in any one of the above embodiments may be implemented as a computer software program tangibly contained in a computer-readable medium, such as the storage unit 1608. In some embodiments, some or all of the computer program may be loaded and/or installed to the electronic device 1600 via the ROM 1602 and/or the communication unit 1609. When the computer program is loaded to the RAM 1603 and executed by the CPU 1601, one or more operations in the method described above may be performed.

A computer non-transitory readable storage medium is further provided by an embodiment of the present application, which stores a computer program, wherein in response to the computer program being executed by a processor, various processes of the method for adjusting the memory capacity in the above embodiments are implemented and the same technical effects may be achieved. In order to avoid repetition, details are not repeated here. The computer non-transitory readable storage medium is, for example, a read-only memory (ROM), a random access memory (RAM), a magnetic disk, or an optical disk.

The above describes only the implementations of the present application, but the scope of protection of the present application is not limited thereto. Any variation or replacement readily conceivable by any skilled person familiar with this technical field within the technical scope disclosed by the present application shall fall within the scope of protection of the present application. Therefore, the scope of protection of the present application shall be subject to the scope of protection of the claims.

1. A method for adjusting a memory capacity, applied to a basic input output system (BIOS), the method comprising:
obtaining serial presence detect (SPD) data of a plurality of types of memories comprising the target memory;
building a data structural body corresponding to each memory parameter in an image of the BIOS;
storing SPD data of each type of the memories in a corresponding data structural body based on memory parameters of each type of the memories; and
storing a data structural body of each type of the memories in a storage address corresponding to each type of the memories;
reading SPD data of a target memory from the image of the BIOS, wherein the SPD data of the target memory is reserved, and the target memory is a physical memory without an SPD controller; and
adjusting a memory capacity of the target memory based on the SPD data of the target memory;
wherein the adjusting the memory capacity of the target memory based on the SPD data of the target memory comprises:
assigning the SPD data of the target memory to the target memory; and
initializing the target memory to adjust the memory capacity of the target memory.

2. (canceled)

3. The method according to claim 1, wherein the storing the SPD data of each type of the memories in the corresponding data structural body based on the memory parameters of each type of the memories comprises:
obtaining memory capacity parameters of each type of the memories set by a user;
replacing original memory capacity parameters in the SPD data of each type of the memories based on the memory capacity parameters, to generate new SPD data of each type of the memories; and
storing the SPD data and the new SPD data in the corresponding data structural bodies, respectively, wherein different SPD data corresponds to different data structural bodies.

4. (canceled)

5. The method according to claim 1, wherein the reading the SPD data of the target memory from the image of the BIOS, wherein the SPD data of the target memory is reserved comprises:
obtaining, in response to server startup, a memory capacity parameter set by a user for the target memory after the BIOS enters an initialization phase; and
reading, from the image of the BIOS, the SPD data, matching the memory capacity parameter, of the target memory.

6. (canceled)

7. The method according to claim 5, wherein the reading, from the image of the BIOS, the SPD data, matching the memory capacity parameter, of the target memory comprises:
determining a target storage address corresponding to the target memory based on a memory type of the target memory; and
reading, based on a preset protocol, the SPD data that matches the memory capacity parameter from the target storage address.

8. The method according to claim 7, wherein the reading, based on the preset protocol, the SPD data that matches the memory capacity parameter from the target storage address comprises:
obtaining a target data structural body corresponding to the memory capacity parameter; and
reading, based on the preset protocol, the SPD data that matches the memory capacity parameter in the target data structural body from the target storage address.

9-10. (canceled)

11. The method according to claim 1, wherein after the adjusting the memory capacity of the target memory based on the SPD data of the target memory, the method further comprises:
checking whether there are uninitialized memories among the memories accessing to a server of the BIOS after the target memory has been initialized;
sequentially recognizing, in response to there being uninitialized memories among the memories, the uninitialized memories among the memories; and
sequentially reading SPD data of the uninitialized memories from the image of the BIOS to sequentially initialize the uninitialized memories.

12. The method according to claim 11, wherein after the checking whether there are uninitialized memories among the memories of the server of the BIOS, the method further comprises:
determining whether the server is started up normally after checking that all the memories have been initialized; and
re-initializing the memories in response to the server being not started up normally.

13. The method according to claim 12, wherein the re-initializing the memories comprises:
obtaining a minimum memory parameter of the memories, wherein the minimum memory parameter is preset;
reading target SPD data corresponding to the minimum memory parameter from the image of the BIOS; and
assigning the target SPD data to the memories and initializing the memories.

14. The method according to claim 12, wherein after the re-initializing the memories, the method further comprises:
in response to the server being started up normally, sequentially reading SPD data of the memories from the image of the BIOS; and
sequentially initializing the memories based on the SPD data of the memories to adjust memory capacities of the memories.

15. (canceled)

16. The method according to claim 12, wherein after the determining whether the server is started up normally, the method further comprises:
ending the memory initialization process in response to the server being started up normally.

17-18. (canceled)

19. An electronic device, comprising:
a memory, a processor, and a computer program stored on the memory and being capable of executing on the processor, wherein the computer program, in response to being executed by the processor, implements the method for adjusting the memory capacity according to claim 1.

20. A computer non-transitory readable storage medium, wherein instructions in the computer non-transitory readable storage medium, in response to being executed by a processor of an electronic device, enable the electronic device to perform the method for adjusting the memory capacity according to claim 1.

21. The method according to claim 1, wherein the SPD data of the target memory the SPD data refers to memory configuration data of the target memory, and the SPD controller refers to a memory configuration controller.

22. The method according to claim 3, wherein before the storing the SPD data and the new SPD data in the corresponding data structural bodies, respectively, the method further comprises:
creating a data structural body corresponding to the new SPD data in the storage address corresponding to each type of the memories to store the new SPD data.

23. The method according to claim 5, wherein the obtaining the memory capacity parameter set by the user for the target memory comprises:
in response to the BIOS entering the initialization phase, displaying an interface of the BIOS; and
obtaining the memory capacity parameter set by the user for the target memory based on the interface of the BIOS.

24. The method according to claim 8, wherein the obtaining the target data structural body corresponding to the memory capacity parameter comprises:
obtaining a corresponding relationship that is pre-recorded between memory capacity parameters and data structural bodies; and
obtaining the target data structural body corresponding to the memory capacity parameter based on the memory capacity parameter and the corresponding relationship.

25. The method according to claim 14, wherein the in response to the server being started up normally, sequentially reading the SPD data of the memories from the image comprises:
in response to the server being started up normally, obtaining memory capacity parameters of each type of the memories reset by a user; and
sequentially reading the SPD data corresponding to the memory capacity parameters from the image based on the memory capacity parameters.

26. The method according to claim 1, wherein the plurality of types of the memories at least comprise memories of different models and capacities from different memory manufacturers.

27. The electronic device according to claim 19, wherein the storing the SPD data of each type of the memories in the corresponding data structural body based on the memory parameters of each type of the memories comprises:
obtaining memory capacity parameters of each type of the memories set by a user;
replacing original memory capacity parameters in the SPD data of each type of the memories based on the memory capacity parameters, to generate new SPD data of each type of the memories; and
storing the SPD data and the new SPD data in the corresponding data structural bodies, respectively, wherein different SPD data corresponds to different data structural bodies.

28. The electronic device according to claim 19, wherein the reading the SPD data of the target memory from the image of the BIOS, wherein the SPD data of the target memory is reserved comprises:
obtaining, in response to server startup, a memory capacity parameter set by a user for the target memory after the BIOS enters an initialization phase; and
reading, from the image of the BIOS, the SPD data, matching the memory capacity parameter, of the target memory.
